(19) United States
(12) Patent Application Publication
(10) Pub. No.: US 2011/0273874 A1
(43) Pub. Date: Nov. 10, 2011

(54) LIGHT-EMITTING DIODE MODULE FOR A VEHICLE, AND DIODE MOUNTING

(75) Inventors: Adèle Verrat-Debailleul, Villers-sur-Coudun (FR); Béatrice Mottelet, Compiegne (FR)

(73) Assignee: SAINT-GOBAIN GLASS FRANCE, Courbevoie (FR)

(21) Appl. No.: 13/125,879

(22) PCT Filed: Oct. 27, 2009
(86) PCT No.: PCT/FR2009/052065

§ 371 Date: Jun. 23, 2011

(30) Foreign Application Priority Data
Oct. 27, 2008 (FR) 0857299

(51) Int. Cl. F21V 9/00

(52) U.S. Cl. 362/231

(57) ABSTRACT

A diode module, for a vehicle, includes a first curved transparent sheet, diodes, each including an emitting chip able to emit at one or more wavelengths in the visible, and guided in the first sheet after injection via the edge face or via the sidewall of one or more holes housing the diodes in one of the main faces of the sheet, and including a bracket supporting the diodes, bordering the glazing, including a clip, for fastening to the glazing, having a middle part, a first discontinuous flange having a first set of tabs, for fastening and/or centering the clip, which are distanced from each other and a second discontinuous flange having a second set of tabs, for fastening the clip, which are distanced from each other, the first and/or second set(s) of tabs thus forming a retainer to retain the diodes in preset vertical positions relative to the first sheet.

The present invention relates to automotive glazing and in particular to glazing units comprising light-emitting diodes.

Vehicles are increasingly making use of light-emitting diodes (LEDs).

Document WO 2006/128941 describes, for example, a panoramic roof with uniform illumination of the entire surface by one or more LEDs. This roof comprises a laminated structure which is composed of an external light-extracting sheet, a central, transparent, light-guiding sheet, and an internal light-diffusing sheet.

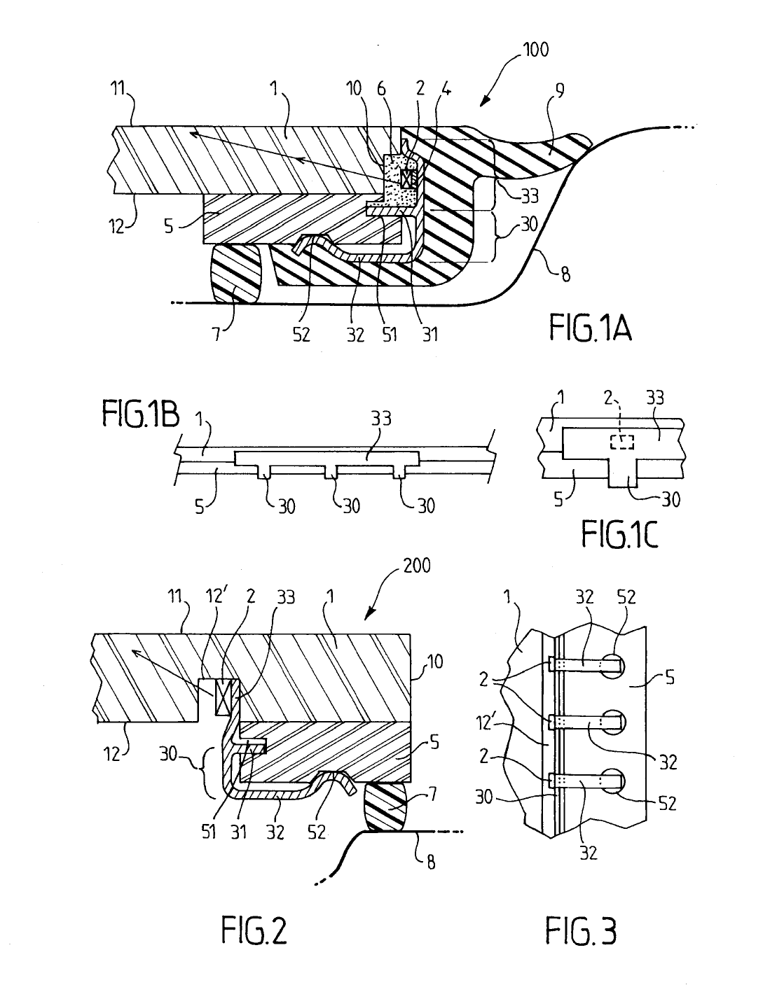

In a first embodiment shown in FIGS. 2 and 3, a support of a lightguide is a bracket of C-shaped cross section on the perimeter of the laminated structure, the lightguide being connected to a diode at its end. This structure is complicated and not compact.

In another embodiment, shown in FIG. 8, the LEDs are mounted on a lateral support which is a bracket with a rectangular cross section fastened to the edge face of the internal and external sheets whereas a hole is provided in the central sheet for housing the diodes.

The desired optical coupling is not guaranteed for all the diodes with such a mounting.

Thus, the invention provides an alternative design for a light-emitting diode module that is reliable, at the very least with a controlled light injection, sturdy and compact while remaining simple to produce and mount.

The present invention also relates to a diode module that meets the requirements of industry (in terms of yield, therefore cost, throughput, automation, etc.), thus making a “low-cost” production possible without sacrificing performance.

For this purpose, the present invention provides a light-emitting diode module, for a vehicle, comprising:
a glazing unit with main faces, the glazing comprising at least one first curved transparent sheet having a first main face and a second main face and an edge face;
light-emitting diodes each comprising an emitting chip able to emit at one or more wavelengths in the visible, and guided in the first sheet after injection via the edge face (whether holed or not) or via the facing sidewall of one or more holes housing the diodes in one of the first or second main faces, guided before extraction via at least one of the first and/or second faces;
a bracket supporting the diodes, bordering the glazing, comprising a clip, for fastening to the glazing, having a part, called a middle part, a first discontinuous flange and a second discontinuous flange;
the first flange having a first set of tabs, for fastening and/or centering the clip, which are distanced from each other, and
the second flange having a second set of tabs, for fastening (or even centering) the clip, which are distanced from each other,
   the first and/or second set(s) of tabs thus forming means for retaining diodes in preset vertical positions (therefore a position along the axis vertical to the mid-plane of the glazing) relative to the first sheet, and doing so independently of the curvature and of any possible variations in the curvature.

Thus, the injection of the light emitted by the diode assembly is controlled perfectly by virtue of the apposite fastening bracket.

The chips are not necessarily aligned with one another. It is enough that they (at the least) remain facing the region for optically coupling to the first sheet, which is therefore the edge face or the sidewall of the hole(s).

In the case of automotive glazings made of mineral glass, the radius of curvature can vary greatly. For roofs, it varies for example between 2000 and 6000 mm. For windows, it may also vary greatly, for example from 200 to 6000 mm. In the smallest side windows, the radius of curvature may vary from 150 mm locally to 2000 mm.

For the case of automotive glazing units made of plastic, the radius of curvature may be about the same or lower than the radius of curvature of the mineral glass. In complex geometries, the radius of curvature is for example about 100 mm with abrupt variations in the radius of curvature.

Curvature tolerances vary depending on the size and the manufacturing method of the glazing. For example, in a side window made of mineral glass the curvature tolerances 5 mm from the edge of the glass are generally about ±0.5 to ±1.5 mm. For the case of roofs, the tolerances vary rather between ±0.5 and ±2.5 mm depending on the size and the method.

For plastic glazing units, the curvature tolerance may be about the same as that of mineral glass or slightly less depending on the methods used for testing the glazing units, taking account of the flexibility of the plastic (depending on the number of reference and/or clamping points, on the orientation (vertical or horizontal) of the glazing during the test, etc.).

The number and the position of the tabs of the first set and/or the second set will depend on the number of diodes, on the space between each diode and on the curvature.

It is preferable, for a good vertical alignment of the diodes facing the coupling region (i.e. minimal fastening and/or centering), for (at least) one or each diode or group of diodes to be (sufficiently) near at least one fastening and/or centering tab in a plane, transverse to the glazing, especially, depending on the mounting of the diodes, a plane transverse to the mid-plane of the glazing or to the edge face of the glazing and/or to the facing sidewall of said hole housing the diodes, said plane passing through said diode or the group of diodes, especially through one diode of said group (the center of the group for example).

The total number of diodes is defined by the size and position of the regions to be illuminated, by the desired light intensity and the required uniformity of the light.

The gap between the tabs of a given set depends on the number and the size of the diodes and on the curvature of the glazing and on whether the tabs of the two sets face or are offset from each other (a larger gap then being possible). It may therefore typically vary between 20 mm and 250 mm.

The length of the fastening and/or centering tabs may vary from 3 to 30 mm. The width of the fastening and/or centering tabs may vary from 2 to 30 mm.

The tabs of a given set may be identical. The tabs of a given set may be aligned with one another. The tabs of the two sets may be identical. The tabs of the two sets may face or be offset from each other.

The (cross) section of the fastening clip is variable and for example:
is substantially U-shaped in the regions with tabs of the first and second sets facing each other;
or substantially L-shaped in the regions with tabs only of the first set or only of the second set;
and in the shape of the middle part (straight line, rectangle, curved line, etc.) in the regions without tabs.

The fastening tabs have, preferably at their ends, clipping parts. The longitudinal cross section of the clipping ends may be relatively freely chosen, for example to be rectangular, trapezoidal, triangular, T-shaped, etc. The cross section of the clipping ends may preferably be curved.

In a first variant, the module comprises a polymer encapsulation, which is especially from 0.5 mm to several cm in thickness, located bordering the glazing and covering all or part of the bracket supporting the diodes, and preferably means for sealing against the liquid encapsulation material injected at a given temperature and pressure.

When applied to vehicles, the encapsulation material is black or tinted (for esthetic reasons and/or for masking purposes). Since the material is not sufficiently transparent at the visible wavelength(s), the sealing means are necessary to ensure good injection of the light into the first sheet.

The encapsulation may be made of polyurethane, especially of RIM-PU (reaction injection molding polyurethane), the crosslinking of the two-component PU occurring in the mold, once both components have been simultaneously injected. This material is typically injected at temperatures as high as 130° C. and at a few tens of bar.

Other encapsulation materials are:
preferably flexible thermoplastics: thermoplastic elastomer (TPE), polyvinyl chloride (PVC), or ethylene-propylene-diene-terpolymers (EPDM), typically injected between 160° C. and 240° C. and as high as 100 bar; and
rigid thermoplastics: polycarbonate (PC), polymethyl methacrylate (PMMA), polyethylene (PE), polypropylene (PP), polyamide (PA66), acrylonitrile butadiene styrene (ABS), or ABSPC, typically injected between 280° C. and 340° C. and between 500 and 600 bar.

To test this seal, optical performance could be compared before and after encapsulation.

As adhesive materials (whether external or internal to the bracket) providing this sealing function against the encapsulation, in the short term, mention may be made of:
a UV-curable adhesive (whether internal or external);
a strip (acrylic, PU, etc.) coated with an acrylic adhesive (whether internal or external);
a transparent adhesive (whether internal or external), PU, silicone, acrylic; or
a thermoplastic resin: PVB, EVA, etc. (whether internal or external).

This encapsulation may form additional sealing means, for example more efficient long-term sealing means, optionally by way of a 5 to 30 μm thick, one-, two- or three-component primary layer, for example based on polyurethane, polyester, polyvinyl acetate, isocyanate, etc., in particular for adhesion to a mineral glass.

Furthermore, in the case of encapsulation on a mineral glass, it may be preferred to proscribe silicone adhesives as external adhesives, because they adhere very well to the glass but will prevent adhesion of the material encapsulated on the glass.

The encapsulation also provides a good esthetic finish and allows integration of other elements or functionalities:
overmolded frames;
one or more reinforcing inserts for fastening the module, especially for modules that open; or
multi-lipped sealing strip (two-lipped, three-lipped, etc.), compressed after mounting on the vehicle.

The encapsulation may take any form, with or without lip, double-sided, triple-sided.

Tubing, in other words a closed-cell sealing strip, may also be bonded to the encapsulation.

Preferably, in the case of an external adhesive, a free space is left on the edge face of the glazing associated with the diode bracket to allow a flush encapsulation, i.e. flush with one of the faces of the glazing, etc.

Sealing means may be used for a number of purposes:
during manufacture of the module, as described above; and
in the long term, for example 5 years, in particular to protect the chips from moisture (water, water vapor) and preferably from cleaning products or washing by high-pressure jets, and to prevent contamination of the light-emission volume (dirt, organic contamination such as molds, etc.).

To test the long-term behavior of the seal, the wet-poultice test may be used.

For example the D47 1165-H7 standard used in the automotive industry describes the H7 wet poultice test. This test consists in embedding the test piece in cotton soaked with deionized water and enclosing the whole lot in a hermetically-sealed bag, then placing the bag in an oven at 65° C. for 7 days. Next, the test pieces are taken out of the oven and, after the soaked cotton has been removed, are kept at 20° C. for 2 hours. The test pieces may finally be inspected and mechanically or functionally tested to evaluate the effect of the moisture on the system. This test corresponds to a number of years of natural aging in a humid and hot environment.

To test the long-term behavior of the seal, a high-pressure waterjet cleaning test may be used, such as the D25 5376 test of strength under high-pressure cleaning used in the automotive industry: pressure as high as 100 bar with a nozzle/housing distance of as much as 100 mm.

Means for sealing against fluid(s) may be chosen from:
an adhesive, called an external adhesive, placed on the surface of the diode bracket, opposite the surface facing the glazing, and protruding beyond the periphery of the glazing, optionally forming all or part of the means for fastening the bracket to the glazing;
an adhesive strip or strips, optionally an enveloping strip, with a part covering the bracket prolonged by the projecting parts;
an adhesive tape or tapes, or an enveloping tape; and/or
sealing means between the glazing and the bracket supporting the diodes, chosen from:
   an adhesive material, for filling the light-emission volume, that is transparent at said wavelength(s), preferably an adhesive, a thermoplastic resin or a double-sided adhesive; or
   an adhesive material for protecting the light-emission volume, which adhesive is placed in regions where the bracket makes contact with the glazing, is transparent at said wavelength(s) of the diodes if it partially fills the coupling volume, and/or is placed to seal the free parts of the diode bracket (the sides for example); and
   a chip-protecting material, transparent at said wavelength(s), identical to or different from the filling material, especially a material for pre-encapsulation of the chips.

The external adhesive may be an adhesive-coated strip:
monolithic, common to all of the diodes; or
in pieces, per diode or group(s) of diodes.

For example, a 0.5 mm thick acrylic strip is chosen.

The strip (having any possible shape) is fastened to the periphery of the glazing, by the edge face of the glazing and/or by one or more main faces of the glazing.

The strip, called then an enveloping strip, may entirely cover the bracket on bottom and top parts and on side parts. In short, the strip has dimensions (width and length) greater than the dimensions of the emergent part of the diode bracket.

The strip may also cover the bracket only on bottom and top parts and not on the side parts (or sides) of the supporting bracket. To make the passage of the connecting medium easier, through-holes may be made in the strip.

Generally, the side parts (or sides) of the supporting bracket are sealed against fluid(s) (encapsulation and/or long-term encapsulation) using “local” adhesive means such as those described above: adhesive, resin, etc.

If the connecting medium passes between the bracket and the glazing, through-holes may be made in the adhesive.

The adhesive strip may comprise a rigid core (metal, etc.) that protrudes beyond the edge of the strip and that is uncovered, so as to make removal of the strip easier when the vehicle is to be repaired or when the diodes are to be changed, etc.

In one embodiment, the adhesive chip-protecting material transparent at said wavelength(s) is identical to the filling material and is chosen from:
an adhesive, embedding the chips and fastening the chips to the glazing; and
a double-sided adhesive, bonded to the chips and the bracket via one adhesive-coated side and bonded to the glazing by the other adhesive-coated side, forming all or part of the fastening means of the bracket.

The light-emission volume naturally varies depending on the radiation pattern of the chips, defined by a main emission direction and an emission cone.

To make manufacture simple (independent of the radiation pattern), the whole volume between the edge face and the chips (whether pre-encapsulated or not), optionally bounded by one or more flanges of the bracket, is filled with the adhesive material.

In a second variant, the module comprises a premounted polymer seal, for example made of an elastomer, especially of TPE (thermoplastic elastomer), or EPDM, having a thickness of a few mm (typically between 2 and 15 mm). The seal may optionally form the supporting bracket for fastening to the glazing (the diodes possibly being on a backing added and fastened to the bracket, for example of rectangular cross section), or the seal may cover all or part of the bracket supporting the diodes.

The seal may be adhesive-coated for its retention. The U-shaped seal may more preferably be held simply by pinching or interfitting with the two main faces of the glazing.

The seal may be of any shape: L-shaped, U-shaped, etc.

The seal may bear the diodes and the backing or fitting bearing the diodes (which has a rectangular cross section, for example). The seal (associated with the backing) may here form the bracket for fastening to the glazing.

The seal may comprise a metal core.

The seal may be demounted at any time. It may nevertheless form additional sealing means, which are for example (more) effective in the long term, optionally formed by one or more lips of the seal, made of elastomer and compressed after fastening.

The elastomer, especially EPDM, has a sealing function and good compression set properties.

So that the bracket and the diodes are positioned correctly, the sealing means used preferably lie between the seal and the periphery of the glazing.

The bracket may be fastened to the glazing before the seal is mounted, the seal is then mounted using any available means (pinching of the U-shaped bracket, bonding using a double-sided adhesive, etc.).

The seal with the diodes may be preferably mounted in an assembly operation, with a single translational movement (by pinching, interfitting, etc.).

As effective long-term means for sealing against moisture and/or cleaning:
ethylene vinyl acetate (EVA) copolymer and polyvinyl butyral (PVB) are avoided;
a (transparent, internal) double-sided adhesive, an (external) single-sided adhesive or a (transparent if internal) adhesive is preferred.

In a first embodiment of the invention, involving a first design of the bracket and of its fastening, the middle part is prolonged at either end by the first and second flanges which are on the side of the second main face, the bracket comprising a part bearing diodes that is separate from and secured to the fastening clip, and the second face is coated, (at least) on its border, with a layer, called a retention layer, having at least one recess for fastening and/or centering the fastening clip.

The retention layer, preferably rigid or semi-rigid (for a better centering and/or fastening precision) may be:
a masking layer, black or tinted, for example a polymer layer, especially a polycarbonate layer on a first polycarbonate sheet; or
an overmolded layer, for example a layer of an encapsulation material (such as that described above, and optionally incorporating one or more reinforcing inserts and/or inserts for fastening the module, as already described above).

The retention layer may have a minimum thickness of 1 mm to 20 mm. The retention layer may be joined to the first sheet using an adhesive.

In this first embodiment, the bracket may be defined as follows:
the first and second flanges are longitudinal flanges, i.e. they extend substantially parallel to the mid-plane of the first sheet, the first flange being nearer to the second face than the second flange;
(at least) one or each centering tab of the first set is housed in a recess, called a centering recess, on one side (side edge) of the retention layer, of greater thickness than the thickness of the centering tab; and
the second set of fastening tabs serves for clipping onto the main free surface of the retention layer, preferably in a full region of the layer, without underlying (centering) recesses.

Preferably, in this first embodiment:
each tab of the second set has a (preferably rounded) end, called a clipping end, housed in a recess in the main free surface, called a clipping recess, of greater width than the width of the clipping end;
the length of the clipping tabs is greater than the length of the centering tabs; and
before the clipping end, the tabs of the second flange are distanced from the free surface, even housed in one or more recesses in the main free surface.

The clipping ends may be aligned or staggered, relative to one another and to the centering tabs.

The centering recess may be individual (specific to each tab) or common to a number (all) of the centering tabs.

This centering recess may be:
of sufficient depth to retain the associated centering tab or tabs in position, for example 2 mm or more;
of width (in other words, thickness) typically of 0.5 mm and 4 mm adjusted to position chips facing the coupling region (edge face, side of a hole, etc.) whatever the curvature and its variations.

The recess may extend from the surface of the first sheet.

The centering and/or clipping tabs may preferably have an especially rectangular cross section (beyond the clipping ends). The centering and/or clipping tabs may be substantially planar (beyond the clipping ends).

The middle part may preferably be distanced from the retention layer and substantially planar or curved.

The part bearing diodes may be substantially planar. The bracket may have a constant thickness.

In one variant of this first embodiment, the middle part (and the secured bearing part) of the diode bracket is preformed with a curvature substantially equal to the nominal curvature of the glazing. The centering tabs may then press against:
the sidewall of the recess closest to the second face (or even against the second face if required), if in this region of the glazing the curvature is lower than the nominal curvature;
the sidewall of the recess furthest from the second face, if in this region of the glazing the curvature is higher than the nominal curvature.

In another variant of this first embodiment, the middle part of the bracket (and the secured bearing part) is planar and flexible before it has been mounted on the glazing and is elastically deformed during its mounting, becoming thus curved following the curvature of the glazing (at least) in the regions fastened to by the tabs. In the middle of the bracket, the centering tabs press against the sidewall of the recess furthest from the second face. On the sides of the bracket, the centering tabs press against the sidewall of the recess closest to the second face (or even against the second face if required).

In another variant of this first embodiment, the centering (and clipping) recesses may be on the external side of the retention layer (the side furthest from the center of the glazing), the part bearing diodes facing the edge face of the first sheet.

Moreover, it is possible to provide a sole that bears on the edge face.

In another variant of this first embodiment, the centering (and clipping) recesses are on the internal side of the retention layer (the side closest to the center of the glazing). Preferably, at least one or each diode (whether the chip is (pre)encapsulated or not) is in a hole (a groove for all the diodes if the bearing part is continuous, or a plurality of holes), the bearing part extending into the hole or holes.

The centering recess(es) preferably have a depth (longitudinal dimension) that is smaller than or equal to the width of the hole(s) for installing the bracket, and if not a through-groove is provided for a side mounting.

In this design, it is not absolutely necessary to provide the sealing means described above (during the encapsulation, and/or for the long term) if, after the module has been mounted, the chips are inside the vehicle, and/or the bracket is not encapsulated.

In this case, a conventional (pre)encapsulation of the chips may be all that is required and it may not be absolutely necessary to seal the light-emission volume if the risk of dirt or any type of pollution getting into this region is limited.

In a second embodiment, involving a second design of the bracket and of its fastening, since the middle part is on or above the retention layer, and the middle part is prolonged at either end by the first and second flanges which are transverse flanges, i.e. they lie in a plane perpendicular to the mid-plane of the first sheet, the first and second sets of fastening tabs serve for clipping, and (at least) one or each tab of the first and second sets (whether aligned or not) has an end, called a clipping end (preferably substantially rounded), housed in a recess in the layer, called the clipping layer, the part bearing diodes being substantially transverse and between the first and second flanges and partially in one or more holes, called diode holes, in the retention layer.

The one or more diode holes are through-holes and the bearing part extends into one or more of the holes, for housing diodes, in the second face.

The clipping recess(es) may be on the main free surface, or on the sides of the retention layer. The retention layer may have a local thickness allowance in the clipping region.

In this second embodiment, the tabs regulate the vertical position of the diodes.

The diodes face the region for optically coupling to the first element, namely the sidewall of the housing hole.

The middle part follows the curvature and its variations after mounting and is preformed if required.

The horizontal position of each diode, i.e. the distance between the chip and the coupling sidewall, is dictated by the centering tabs. This distance is for example about 0.5 mm.

To limit the risk of inclination (angular disorientation) of the bearing part, it is possible to choose a suitable size for the diode housing. The one or more diode holes and/or housing holes are then preferably slightly wider than the cumulative width of the diode and the bearing part.

The part bearing diodes may have a constant, for example rectangular, cross section.

The part bearing diodes may also be discontinuous, with a cross section that is locally (at the diodes) constant, for example rectangular, and with regions recessed, preferably as far as the middle part, between the diode regions.

In at least one or each diode region of the bearing part, it is possible to provide additional longitudinal fitting tabs, which are (slightly) longer than the thickness of the diode, and in the retention layer, which tabs may possibly press against the recess when the receiving part is inclined, so as to prevent the chip from touching the sidewall.

Between the diode regions of the discontinuous bearing part, it is possible to provide additional short, i.e. shorter than the thickness of the retention layer, horizontal centering tabs, which tabs are housed in additional recesses in the retention layer.

If the bearing part is sufficiently recessed between the diode regions, this part may be added to the middle part and fastened by any means.

If the bearing part is full, the middle part and the bearing part are preferably a single part.

In a third embodiment of the invention involving a third design of the bracket and of its fastening, the middle part bears diodes and tabs, the local tabs of the first and second sets being fastening tabs for internal clipping, and said tabs being longitudinal and making contact with opposite longitudinal faces of one or more holes provided in the edge face of the first sheet.

The module is compact. The tabs regulate the vertical position of the diodes.

The separation between the fastening tabs of the first set and those of the second set is greater than the thickness of the hole or holes in the edge face so as to provide a better clipping action.

In one variant of this third embodiment, the middle part is preformed with a curvature substantially equal to the nominal curvature of the glazing.

In one region of the glazing, the curvature is lower than the nominal curvature, the middle part tending to be vertically offset in one direction. One of the sets of tabs is therefore pressed harder against the glazing.

In one region of the glazing, the curvature is lower than the nominal curvature, the middle part tending to be vertically offset in the other direction. The other of the sets of pads is therefore pressed harder against the glazing.

In another variant of this third embodiment, the middle part is planar and flexible before it has been mounted on the glazing and is elastically deformed during its mounting, becoming thus curved following the curvature of the glazing (at least) in the regions fastened to by the tabs. In the middle of the bracket, the middle part tends to be vertically offset in one direction. One of the sets of tabs is therefore pressed harder against the glazing. On the sides of the bracket, the middle part tends to be vertically offset in the other direction. The other of the sets of pads is therefore pressed harder against the glazing.

In another variant of the third embodiment, the middle part bears diodes and tabs, and the local tabs of the first and second sets are fastening tabs for internal clipping, said tabs being transverse, making contact with opposite, transverse faces of one or more holes provided in the second main face of the first sheet.

In this variant, for an optical coupling via at least one of the transverse faces of the hole, it is possible for example to choose:
diodes on a backing fastened onto the middle part and protruding beyond the tabs;
diodes emitting obliquely into a region without an emission-hindering tab; or
diodes emitting obliquely into a region with a tab recessed to allow the emission through.

In a fourth embodiment of the invention involving a fourth design of the bracket and of its fastening, the middle part bears diodes, facing the edge face of the glazing (for example the first sheet), and is prolonged at either end by the first and second flanges, the first flange being associated with one of the main faces of the glazing, the second flange being associated with another of the main faces of the glazing, and the local tabs of the first and second sets being fastening tabs for clipping and centering.

In this variant, the term “clip” is understood to have a broad sense (possibly fastening by pinching or interfitting).

The length of the bracket varies, depending on the number of diodes and the extent of the area to be illuminated, especially from 25 mm to the length of one edge of the glazing (for example 1 m).

The bracket may be perforated so that an external adhesive can embed the chips and/or fill the optical-coupling volume.

The bracket may be made of a flexible, dielectric or electrically conductive material, for example a metal (aluminum etc.), or a composite.

The bracket may, if required, be a sealant against fluid(s) (injection and/or long-term material), unless this function is, as is possible, performed by another external enveloping element (external adhesive, premounted seal, etc.).

The bracket may be monolithic or made of a plurality of pieces.

The bracket may be produced by folding.

For increased compactness and/or a simplified design, the bracket may furthermore have one or more of the following features:
it may be deformable;
it may be thin (sufficiently thin so as to be deformable), especially less than or equal to 0.2 mm thick, especially less than or equal to 3 mm thick, for example between 0.1 and 3 mm thick;
it may be opaque, for example made of copper or stainless steel; and/or
it may extend along the entire length of a hole forming a groove.

The invention also covers the bracket supporting the diodes (preferably with the diodes) for fastening to a vehicle-borne module such as that described in the preceding embodiments.

The diodes may be (pre)assembled on a backing or backings (with tracks for the supply of electrical power) that is/are preferably thin, especially being less than or equal to 1 mm thick, even 0.1 mm thick, which backing(s) is/are fastened to the (for example metal) brackets.

Otherwise the bracket itself may bear directly the chips and the tracks for the supply of electrical power.

For increased compactness and/or to increase the window region of the glazing, the distance between the part bearing chips and the first sheet is preferably less than or equal to 5 mm, and preferably the distance between the chips and the first sheet is less than or equal to 2 mm. In particular, it is possible to use chips having a width of 1 mm, a length of 2.8 mm and a height of 1.5 mm.

A plurality of identical or similar diode brackets may be provided instead of a single bracket, especially if the regions to be illuminated are very distant from one another.

A bracket with a given reference size, multiplied depending on the size of the glazing and the requirements, may be provided.

To quantify the transparency of the internal sealing means to the radiation wavelength(s), materials with an absorption coefficient of 25 m⁻¹ or less, or even more preferably 5 m⁻¹, may preferably be chosen.

Moreover, to minimize losses at the interface with the first sheet, a refractive index that matches as closely as possible that of the first sheet may furthermore be chosen, for example a index difference of 0.3 or less, even 0.1 or less.

The coupling edge or edges of the first sheet may preferably be rounded. Thus, in particular when the light-emission volume is air-filled, it is possible to use the refraction at the interface between the air and the appropriately-shaped first sheet (which has a rounded edge, even a beveled edge, etc.) to focus the rays in the first sheet.

The coupling edges of the first sheet may preferably be roughened (diffusing). In this case, the scattering losses are limited by virtue of the internal adhesive sealing means because the adhesive is incorporated in the anfractuosities of the roughened edge.

The transmission factor of the first sheet, near the emission peak in the visible of the chips (perpendicular to the main faces) is preferably 50% or higher, even more preferably 70% or higher, and even 80% or higher.

The glazing may be a single glazing pane (a single sheet), the first sheet being made of glass or plastic, especially PC, etc.

The glazing may be laminated (several sheets) formed from:
a first, thick or thin, transparent, mineral glass (float glass, etc.) or organic (PC, PMMA, PU, ionomer resin, polyolefin) sheet;
a lamination interlayer made of a given lamination material; or
a second sheet (whether opaque or not, transparent, tinted, made of mineral glass, or an organic material having various functions: solar-control coating, etc.).

Conventional lamination interlayers include flexible PU, or a plasticizer-free thermoplastic such as ethylene vinyl acetate (EVA) copolymer or polyvinyl butyral (PVB). These plastics are for example between 0.2 mm and 1.1 mm thick, especially between 0.38 and 0.76 mm thick.

The first sheet/interlayer/second sheet combination may especially be chosen to be:
mineral glass/interlayer/mineral glass;
mineral glass/interlayer/polycarbonate; or
polycarbonate (whether thick or not)/interlayer/mineral glass.

In the present description, unless specified, the term “glass” is understood to mean a mineral glass.

It is possible to cut the edge of the first sheet (before tempering) of a single or laminated glazing so as to house the diodes therein.

The structure may comprise laminated glazing formed from the first glass sheet, a lamination interlayer chosen to be diffusing, for example translucent PVB, so as to spread the light, and a second glass sheet, optionally with an external main face that is diffusing (because of a texture or an additional layer).

However, preferably, the glazing is a single glazing, even made of plastic, so as to be more compact and/or lighter.

The first and/or second sheets may be of any shape (rectangular, square, round, oval, etc.).

The first sheet may preferably be made of a soda-lime glass, for example Planilux glass from Saint Gobain Glass.

The second sheet may be tinted, for example made of Venus glass from Saint Gobain Glass.

The glass may optionally have previously been subject to a heat treatment of the hardening, annealing, tempering or bending type.

The extraction face of the glass may also be frosted, sand-blasted, screen-printed, etc.

The module is intended to equip any vehicle:
side windows, roof, rear window, or windshield of a land-based vehicle: an automobile, service vehicle, truck or train;
window or windshield of an airborne vehicle (airplane, etc.); or
windows or roof of an aquatic vehicle (boat or submarine).

The panoramic roof of the prior art (WO 2006/128941) is fastened by bonding peripheral edges of the external sheet to the body of the roof. The diodes and the peripheral bonding region are masked by internal upholstery.

The invention increases the available range of illuminating roofs. This is because the LED-supporting module is suitable for any roof configuration, in particular roofs mounted from the outside to the body, both fixed roofs and sun-roofs.

The light extraction (the type and/or the position of the chips) is adjusted to provide:
an ambient light or a light for reading, especially visible inside the vehicle;
a luminous signal, especially visible outside the vehicle:
   activated using a remote control: so as to locate the vehicle in a parking lot or elsewhere, or to indicate the (un)locking of the doors;
   a safety signal, for example rear brake lights; or
   a light that is substantially uniform over the entire light-extraction surface (one or more light-extraction regions, common or separate functions).

The light may be:
continuous and/or intermittent; and
monochromatic and/or polychromatic, or white.

Visible inside the vehicle, the light may thus have a nighttime-illumination function or a display function for displaying all kinds of information, such as designs, logos, alphanumeric signs or other signs.

As decorative patterns one or more luminous strips or a peripheral luminous frame may be formed.

It is possible for a single extraction face (inside the vehicle or outside) to be provided, the other side being absorbent or preferably reflective.

Insertion of diodes into these glazing units makes the following other signaling functionalities possible:
display of indicator lights intended for the driver of the vehicle or for the passengers (for example: an engine temperature warning light displayed on the windshield of the automobile, or an indicator showing that the system for electrically deicing the window is in operation, etc.);
display of indicator lights intended for persons outside the vehicle (for example: an indicator, in the side windows, showing that the vehicle alarm is in operation);
luminous display on vehicle windows (for example a flashing luminous display on emergency vehicles, or a security display with low electrical power consumption indicating the presence of a vehicle in danger).

The module may comprise a diode that can receive control signals, especially in the infrared, for remote control of the diodes.

Naturally, the invention also relates to a vehicle incorporating the module defined above.

The diodes may be simple semiconductor chips, for example having a size of about 100 μm or 1 mm.

The diodes may however comprise a protective packaging (whether temporary or not) for protecting the chip during handling or to improve the compatibility between the chip materials and other materials.

The diodes may be encapsulated, i.e. they may comprise a semiconductor chip and packaging, for example made of an epoxy-type resin or of PMMA, encapsulating the chip and the functions of which are multifarious: protection against oxidation and moisture, diffusing or focusing element, wavelength conversion, etc.

The diode may especially be chosen from at least one of the following LEDs:
a diode with electrical contacts on opposite faces of the chip, or on the same face of the chip;
a diode emitting parallel to the (faces of the) electrical contacts;
a diode the main emission direction of which is perpendicular or oblique to the emitting face of the chip;
a diode having two main emission directions, oblique to the emitting face of the chip, giving a batwing shape, the two directions for example being centered on angles between 20° and 40° and between −20° and −40° with apex half-angles of around 10° to 20°,
a diode having (only) two main emission directions, oblique to the emitting surface of the diode, centered for example on angles between 60° and 85° and between −60° and −85°, with apex half-angles of about 10° to 30°; and
a diode placed for guiding in the edge face or to emit directly via one or both faces, or via the hole (the diode is then called an inverted diode).

The emission pattern of a source may be Lambertian.

Typically, a collimated diode has an apex half-angle that may be as low as 2° or 3°.

The module may thus incorporate all functionalities known in the glazing field. Among functionalities that may be added to the glazing, mention may be made of the following: a hydrophobic/oleophobic layer, a hydrophilic/oleophilic layer, an antisoiling photocatalytic layer, a thermal-radiation-reflecting (solar control) or infrared-reflecting (low-E) multilayer or an antireflection layer.

The structure may advantageously comprise a diffusing mineral layer associated with one of the main faces, which is an illuminating face (by extraction of the light).

The diffusing layer may be composed of elements, containing particles and a binder, the binder being used to agglomerate the particles together.

The particles may be metal particles or metal oxide particles, the size of the particles may be between 50 nm and 1 μm, and preferably the binder may be a mineral binder for heat resistance.

In a preferred embodiment, the diffusing layer consists of particles agglomerated in a binder, said particles having a mean diameter of between 0.3 and 2 microns, said binder being in a proportion of between 10 and 40% by volume, and the particles forming aggregates the size of which lies between 0.5 and 5 microns. This preferred diffusing layer is particularly described in patent application WO 01/90787.

The particles may be chosen from semitransparent particles and preferably from mineral particles such as oxide, nitride or carbide particles. The particles will preferably be chosen from silica oxides, alumina oxides, zirconium oxides, titanium oxides and cerium oxides, or a mixture of at least two of these oxides.

For example, a diffusing mineral layer of about 10 μm is chosen.

Other details and advantageous features of the invention will become clear on reading about the examples of modules according to the invention illustrated in the following figures:

FIGS. 1A, 2, 4A, 6 and 11 show partial schematic views in cross section of diode modules in various embodiments of the invention;

FIGS. 1B and 1C each show a partial schematic view of the edge face of a diode module in one embodiment of the invention;

FIG. 3 shows a partial schematic bottom view of a diode module in one embodiment of the invention; and

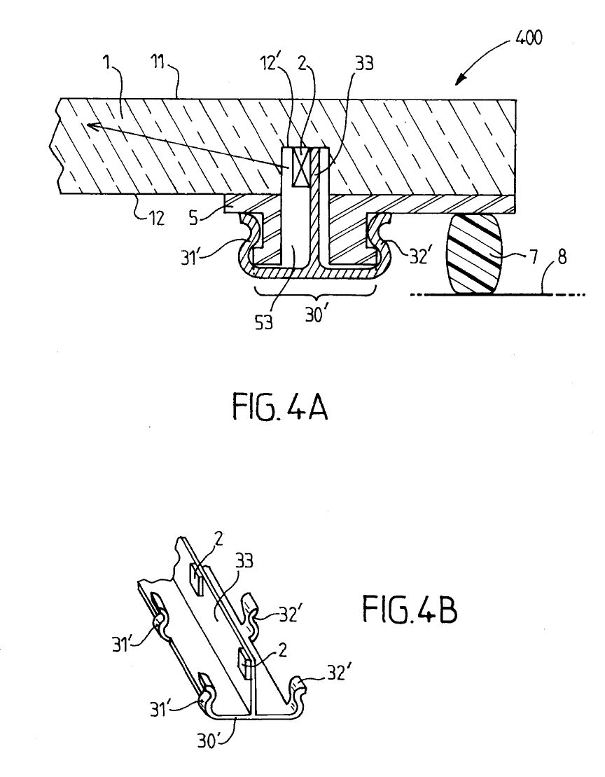

FIGS. 4B, 5B and 7 to 10 show partial schematic top or side views of diode fastening brackets in embodiments of the invention.

For the sake of clarity the various elements of the objects shown are not necessarily drawn to scale.

Moreover, for the sake of simplicity, curved glazing units are shown as being planar.

FIG. 1 shows a partial schematic view in cross section of a diode module 100 in a first embodiment of the invention.

This module 100 comprises a single glazing pane comprising a first curved, for example rectangular, transparent sheet 1 having a first main face 11 and a second main face 12, and an edge face 10, for example a sheet of polycarbonate 5 mm in thickness.

The second main face 12 is coated on its border with a black polycarbonate masking layer 5, 3 mm in thickness.

The module comprises LEDs (2) each having an emitting chip (2) able to emit one or more wavelengths in the visible and guided in the first sheet after injection via the edge face (optionally holed, for example in a corner).

As a variant, this may be a glass sheet, with a thickness equal to 2.1 mm, preferably not holed, or a glazing pane laminated with a second sheet of glass, optionally tinted to provide a solar-control function (Venus glass, etc.) and/or covered with a solar-control coating (the second sheet of glass being laminated by way of a lamination interlayer, for example a PVB interlayer 0.76 mm in thickness).

A bracket 3, supporting the diodes, borders the glazing. It comprises a clip 30 for fastening to the glazing with a part, called a middle part, prolonged at either end by a first discontinuous flange 31 and a second discontinuous flange 32. This bracket is monolithic, made of a metal (stainless steel, aluminum, etc.), thin, deformable, and 0.2 mm in thickness.

As shown in FIG. 1B, the first flange has a first set of tabs, for centering the clip 31, which are distanced from each other and the second flange has a second set of tabs, for fastening the clip 32, which are distant from each other.

The bracket comprises a part bearing diodes 33, separate from and secured to the fastening clip, facing the holed edge face of the first sheet, and for example of rectangular cross section.

The second main face is coated on its border with the masking layer, thus forming a retention layer 5 with recesses 51 and 52 for fastening and/or centering the fastening clip 30.

More precisely, the first and second flanges are longitudinal 31, 32, i.e. they extend substantially parallel to the mid-plane of the first sheet 1, the first flange being closer to the second face 12 than the second flange, and:
each centering tab of the first set is housed in a recess, called a centering recess 51, in an external side of the retention layer 5, of thickness greater than the thickness of the centering tab, for example a common groove; and
the second set of fastening tabs serves for clipping onto the main free surface of the retention layer (5) via rounded clipping ends housed in clipping recesses 52.

The first and second sets of tabs thus form means for retaining diodes 2 in preset vertical positions relative to the coupling edge face of the first sheet.

For each diode or group of diodes in particular is (sufficiently) near at least one tab for fastening and/or centering the clip in a plane transverse (perpendicular) to the glazing and passing through said diode or said group of diodes, as shown in FIG. 1C.

The diodes are typically of small size, a few mm or less, do not comprise optics (a lens) and are preferably not pre-encapsulated.

The distance between the part bearing diodes 33 and the edge face 10 is minimized, for example from 5 mm. The distance between the chip and the holed edge face is from 1 to 2 mm.

The main emission direction is perpendicular to the face of the semiconductor chip, for example with a multiple-quantum-well active layer, in AlInGaP or another semiconductor technology.

The light cone may be a Lambertian cone of ±60°.

The emission peak directly strikes the faces 11 and 12 (for example part 11A) of the sheet which reflect the light.

The light is preferably extracted (not shown here) via the face inside the vehicle, by any means: sand-blasting, etching with an acid, a diffusing layer, screen-printing, etc.

Therefore, a light-emission volume is defined between each chip and the edge face of the first sheet.

Each chip and the light-emission volume must be protected from any pollution: water, chemicals, etc. both in the long term and during the manufacture of the module 100.

In particular, it is useful to provide the module with a polymer encapsulation 9, about 2.5 mm in thickness, on the border of the glazing and this encapsulation, by covering the diode bracket, ensures long-term sealing (against water, cleaning products, etc.).

The encapsulation also provides a good esthetic finish and allows integration of other elements or functionalities (reinforcing inserts, etc.).

The encapsulation 9 has a lip, and is double-sided. The encapsulation 9 is for example made of black polyurethane, especially RIM-PU (reaction injection molding polyurethane). This material is typically injected at temperatures as high as 130° C. and at a few tens of bar.

The black encapsulation material is not transparent at the visible wavelength(s) of the diodes. Therefore, to ensure good injection of the light into the first sheet, sealing means are used to seal against the liquid encapsulation material. This may be an adhesive 6 that embeds the chips and fills the light-emission volume.

For a flush encapsulation, it is preferable for a top part of the edge face 1 to be left free.

The module 100 may for example form a fixed panoramic roof of a land-based vehicle, or as a variant of a boat, etc. The roof is mounted from the outside and the module is bonded to the body 8 using an adhesive 7.

The module 100 may form for example a panoramic sun-roof of a land-based vehicle, or as a variant of a boat. The roof is mounted from the outside.

As a variant, the encapsulation of the module 100 is modified as follows:
the lip is removed;
fastening inserts for opening the module are added; and/or
EPDM tubing, in other words a closed-cell sealing strip, or else a multi-lipped sealing strip, is added against the encapsulation, which strip is compressed after mounting on the vehicle.

The multi-lipped sealing strip may also be incorporated into the encapsulation.

In another variant, the masking layer is replaced with an overmolded layer, for example identical to or compatible with the encapsulation material 9.

In another variant, the encapsulation 9 is replaced with a premounted seal, for example made of an elastomer, optionally with one face with the premounted bracket and with the adhesive 6. The seal may even form the fastening bracket and a backing, for example a PCB, is preferably inserted with the diodes.

The first sheet is on the inside of the vehicle. Light is preferably extracted via the face 12.

Diodes emitting white light may be chosen for an ambient lighting, or a light for reading, etc.

A number of brackets may of course be provided on a given edge or on separate edges, the brackets having identical or separate functions (the power, the light emitted, the position and the extent of the light-extraction regions may be suitably chosen).

The light-extraction may form a luminous design, for example a logo or a trademark, or a light show (with music etc.).

FIG. 2, respectively, shows a partial schematic view in cross section of a diode module 200 in a second embodiment of the invention.

This module 200 differs from the module 100 mainly in the positioning of the fastening bracket.

The centering groove 51 is on the internal side of the retention layer 5. Each diode is in a hole 12′, for example a groove, common to the diodes 12′, which borders the second main face 12.

The optical-coupling region is the sidewall of the groove facing the chips.

The bearing part 33 extends into the diode groove of depth greater than or equal to the width of the diode groove.

The fastening tabs and the clipping grooves are shown in FIG. 3.

The roof is mounted from the outside and the module is bonded to the body 8 using an adhesive 7 which is chosen to provide a long-term seal against fluids and which is closer to the edge of the glazing than the fastening bracket and the diodes.

The chips may just be pre-encapsulated.

FIG. 4A, respectively, shows a partial schematic view in cross section of a diode module 400 in another embodiment of the invention.

This module 400 differs from the module 200 in the geometry of the fastening bracket.

The middle part (30′) is above the main free surface of the retention layer (5).

The first and second flanges are transverse 31′, 32′, i.e. they lie in a plane perpendicular to the mid-plane of the first sheet. The first and second sets of fastening and centering tabs serve for clipping, each tab of the first and second sets having a rounded end, called a clipping end, housed in a recess in the layer, called the clipping layer, of the notch type. The masking layer has a thickness allowance in the clipping region.

The part 33 bearing diodes is still substantially transverse (vertical) but between the first and second flanges and partially in a single through-hole 53, called a diode hole, in the retention layer. The bearing part extends into a groove, for housing the diodes, in the second face (one hole per diode or group of closely-spaced diodes).

As shown in FIG. 4B, the bearing part has a cross section that is uniform over its length.

As a variant, its cross section could be discontinuous, recessed between the regions bearing diodes, which face the fastening tabs 31′, 32′. It is then possible for the recesses 53 and 12′ to be local recesses.

FIG. 5A, respectively, shows a partial schematic view in cross section of a diode module 500 in another embodiment of the invention.

This module 500 differs from the module 100 especially in the geometry of the fastening bracket and its fastening.

The middle part bears diodes and tabs. As shown in FIG. 5B in greater detail the tabs of the first and second sets are longitudinal fastening tabs 31″, 32″ for internal clipping and centering.

The tabs make contact with the sidewalls of one or more holes 10′ provided in the edge face of the first sheet.

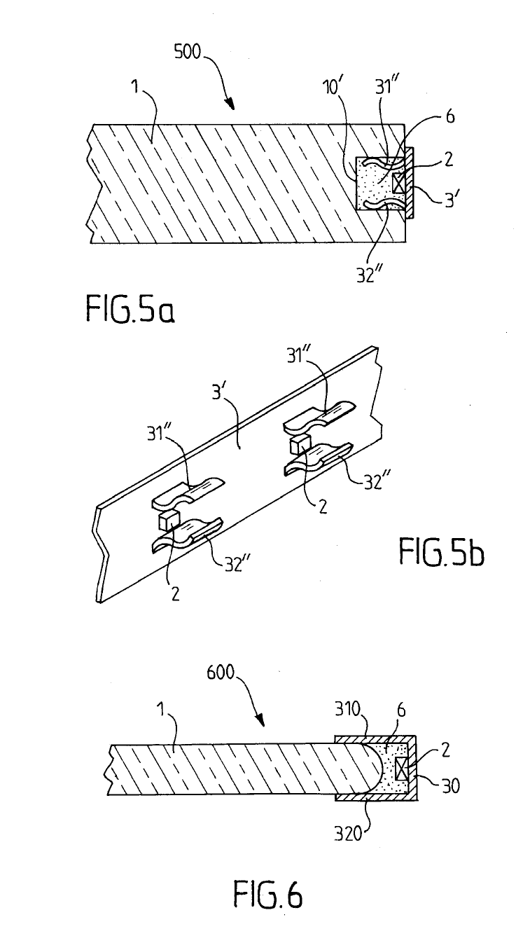

FIG. 6, respectively, shows a partial schematic view in cross section of a diode module 600 in another embodiment of the invention.

This module 600 differs from the module 100 especially in the geometry of the fastening bracket and its fastening.

The middle part 30 bears diodes, facing the edge face of the first sheet, and is prolonged at either end by the first and second flanges 310, 320.

The first flange 310 is associated with the first main face 11 of the glazing 1, and the second flange 320 is associated with the second main face 12 of the glazing, the tabs of the first and second sets being for fastening, clipping, and centering.

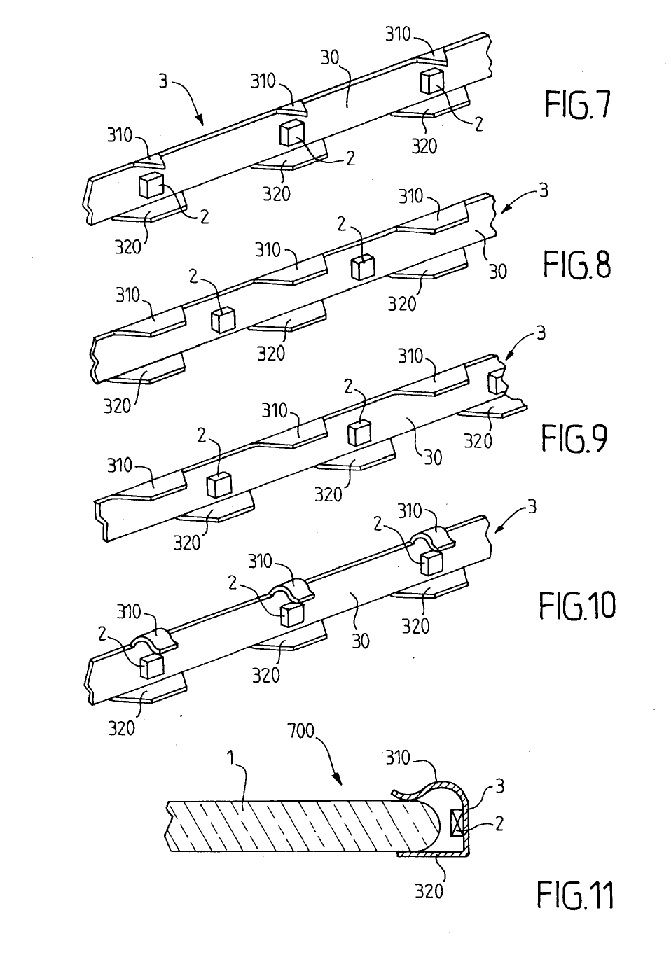

Various examples of this type of bracket of locally U-shaped or L-shaped cross section are shown in FIGS. 7 to 10:
the first and second sets of tabs face each other (cf. FIGS. 7, 8 and 10) and are preferably aligned with each diode or group of closely-spaced diodes (cf. FIGS. 7 and 10);
the first and second sets of tabs are staggered (cf. FIG. 9) and preferably aligned with each diode or group of closely-spaced diodes;
the first and second sets of tabs have identical (trapezoidal) shapes (cf. FIGS. 8 and 9); and
the first and second sets of tabs have separate shapes: trapezoidal and triangular (cf. FIG. 7) or trapezoidal and U-shaped (cf. FIG. 9).

If the bracket is precurved, the middle part may be rigid, only the fastening tabs being flexible.

The cross-sectional view of the module 700 with the bracket of FIG. 10 is shown in FIG. 11. As a variant, the second set may be identical to the first set.

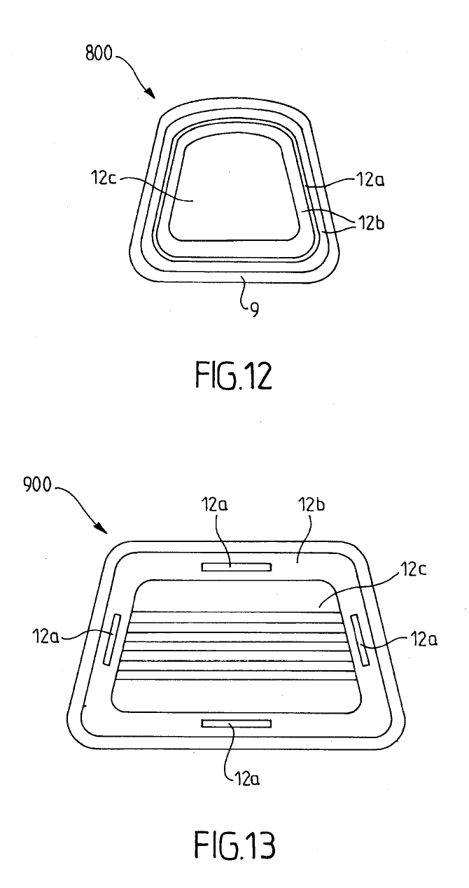

The modules described above are for example mounted as a side window 800 (the external side is shown in FIG. 12) with a window region 12c or as a rear window 900 for a land-based vehicle (the external side is shown in FIG. 13).

The light-extraction surface 12a (on the internal side) is covered with a black masking region 12c (on the internal side). The encapsulation 9 surrounds the side window.

The light is seen from the exterior (means of locating the vehicle, for the side or rear window, brake light for the rear window, etc.).

1. A light-emitting diode module, for a vehicle, comprising:
a glazing with main faces, the glazing comprising at least one first curved transparent sheet having a first main face and a second main face and an edge face;
light-emitting diodes each comprising an emitting chip able to emit at one or more wavelengths in the visible, and guided in the first sheet after injection via the edge face or via the facing sidewall of one or more holes housing the diodes in one of the first or second main faces;
a bracket supporting the diodes, bordering the glazing, comprising a clip, for fastening to the glazing, having a middle part, a first discontinuous flange and a second discontinuous flange; and
the first flange having a first set of tabs, for fastening and/or centering the clip, which are distanced from each other, the second flange having a second set of tabs, for fastening the clip, which are distanced from each other, the first and/or second set(s) of tabs thus forming a retainer configured to retain diodes in preset vertical positions relative to the first sheet.

2. The diode module, for a vehicle, as claimed in claim 1, wherein one or each diode or group of diodes is near at least one tab for fastening and/or centering the clip in a plane, transverse to the glazing, especially transverse to the mid-plane of the glazing or to the edge face of the glazing, passing through said diode or said group of diodes, especially through one diode of said group.

3. The diode module, for a vehicle, as claimed in claim 1, comprising a polymer encapsulation located bordering the glazing and covering all or part of the bracket supporting the diodes, and preferably a seal against the liquid encapsulation material injected at a given temperature and pressure.

4. The diode module, for a vehicle, as claimed in claim 1, comprising a polymer seal located on the periphery of the glazing, the seal forming the supporting bracket for fastening the diodes to the glazing, or the seal covering all or part of the bracket supporting the diodes.

5. The diode module, for a vehicle, as claimed in claim 1, wherein the middle part is prolonged at either end by the first and second flanges which are on the side of the second main face, the bracket comprising a part bearing diodes that is separate from and secured to the fastening clip, and the second main face is coated, on its border, with a retention layer, having at least one recess for fastening and/or centering the fastening clip.

6. The diode module, for a vehicle, as claimed in claim 5, wherein the retention layer is a masking layer, especially made of black polycarbonate, or a layer of an encapsulation material.

7. The diode module, for a vehicle, as claimed in claim 5, wherein:
the first and second flanges are longitudinal flanges that extend substantially parallel to the mid-plane of the first sheet, the first flange being nearer to the second face than the second flange;
one or each centering tab of the first set is housed in a centering recess, on one side of the retention layer, of greater thickness than the thickness of the centering tab; and
the second set of fastening tabs serves for clipping onto the main free surface of the retention layer.

8. The diode module, for a vehicle, as claimed in claim 7, wherein the centering recess or recesses are on the external side of the retention layer, the part bearing diodes facing the edge face of the first sheet.

9. The diode module, for a vehicle, as claimed in claim 7, wherein the centering recesses are on the internal side of the retention layer and wherein, preferably, one or each diode is in a hole, the bearing part extending into the hole or holes.

10. The diode module, for a vehicle, as claimed in claim 5, wherein the middle part is on or above the retention layer, and the middle part is prolonged at either end by the first and second flanges which are transverse flanges that lie in a plane perpendicular to the mid-plane of the first sheet, the first and second sets of fastening and centering tabs serving for clipping, one or each tab of the first and second sets having a clipping end, housed in a recess in the clipping layer, the part bearing diodes being substantially transverse and between the first and second flanges and partially in one or more diode holes, in the retention layer, the one or more diode holes being through-holes and the bearing part extending into one or more of the holes, for housing diodes, in the second face.

11. The diode module, for a vehicle, as claimed in claim 1, wherein the middle part bears diodes and tabs, the tabs of the first and second sets being longitudinal fastening tabs for internal clipping and centering, and said tabs making contact with longitudinal faces of one or more holes provided in the edge face of the first sheet.

12. The diode module, for a vehicle, as claimed in claim 1, wherein the middle part bears diodes and tabs, and the local tabs of the first and second sets are fastening tabs for internal clipping, said tabs being transverse, making contact with opposite, transverse faces of one or more holes provided in the second main face of the first sheet.

13. The diode module, for a vehicle, as claimed in claim 1, wherein the middle part bears diodes, facing the edge face of the first sheet, and is prolonged at either end by the first and second flanges, the first flange being associated with one of the main faces of the glazing, the second flange being associated with another of the main faces of the glazing, and the tabs of the first and second sets being fastening tabs for clipping and centering.

14. The diode module, for a vehicle, as claimed in claim 1, characterized in that wherein the distance between the part bearing chips and the first sheet is preferably less than or equal to 5 mm, and/or the distance between the chips and the first sheet is less than or equal to 2 mm.

15. The diode module, for a vehicle, as claimed in claim 1, wherein by extracting the guided light an ambient light, a light for reading, or a luminous signaling display is formed.

16. A method comprising providing a diode module, for a vehicle, as claimed in claim 1, as:
side windows, roof, rear window, or windshield of a land-based vehicle, especially an automobile, service vehicle, truck or train;
window or windshield of an airborne vehicle; or
windows or roof of an aquatic vehicle, boat or submarine.

17. A vehicle incorporating the module as claimed in claim 1.

18. A diode-supporting bracket for fastening onto a curved glazing of a vehicle module as claimed in claim 1.
